(19) United States
(12) Patent Application Publication
(10) Pub. No.: US 2002/0083143 A1
(43) Pub. Date: Jun. 27, 2002

(54) UPnP architecture for heterogeneous networks of slave devices

(75) Inventor: Doreen Yining Cheng, Los Altos, CA (US)

Correspondence Address: Edward Blocker, c/o Philips Electronics North America Corporation, Corporate Intellectual Property Department, 580 White Plains Road, Tarrytown, NY, 10591-5190, US

(73) Assignee: PHILIPS ELECTRONICS NORTH AMERICA CORPORATION

(21) Appl. No.: 09/736,999

(22) Filed: Dec. 13, 2000

(51) Int. Cl. G06F 15/16

(52) U.S. Cl. 709/208; 709/246

(57) ABSTRACT

A non-IP (Internet Protocol) network is provided with UPnP (Universal Plug and Play) proxy enabling and interfacing logic. The UPnP enabling logic provides the modules required to effect the UPnP addressing, discovery, and description processes for each of the devices on one or more non-IP networks. Each of the non-IP networks may use the same or different network technologies, such as USB, Bluetooth, IEEE 1394, Home API, HomeRF, Firefly, X-10, and so on. During the UPnP control and event phases, the system provides the appropriate control transformation and event proxy processes to communicate commands to each non-UPnP-compatible device in the network, corresponding to the UPnP control commands received from a UPnP control object, and to communicate event status messages to and from the non-UPnP-compatible devices and the UPnP control object.

### BACKGROUND OF THE INVENTION

1. Field of the Invention

This invention relates to the field of control systems, and in particular to the control of non-UPnP-compliant slave devices via a Universal Plug and Play (UPnP) object, or application.

2. Description of Related Art

“Universal Plug and Play (UPnP) is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. Universal Plug and Play is a distributed, open networking architecture that leverages TCP/IP and the Web technologies to enable seamless proximity networking in addition to control and data transfer among networked devices in the home, office, and public spaces.”¹ “Universal Plug and Play Device Architecture”, Version 1.0, Jun. 8, 2000, ©1999-2000 Microsoft Corporation, incorporated by reference herein.

Other networking solutions are also available for control and data transfer among networked devices in the home, office, and public spaces. Standards continue to be developed which will allow devices of varying types and varying vendors to be controlled by a common controller. The HAVi architecture, the Home API initiative, the Universal Serial Bus (USB), HomeRF Lite, and the Bluetooth standard, each involving substantial contributions from Philips Electronics, the OSGI/Jini technology of Sun Microsystems, Inc., and others, have been developed to enhance the interoperability of multiple devices in a network.

Each of the available network solutions has particular advantages and disadvantages. The USB interface, for example, is relatively inexpensive, and, as such, is incorporated into many computer peripheral devices, such as keyboards, mice, pointing devices, and so on. The USB also provides a fairly high speed connectivity at this low cost, and has been adopted as a standard interface for video information transfer, such as from a video camera. The USB, however, has a limited cable length specification of less than 30 meters, and in some applications, less than 5 meters. The UPnP networking architecture, on the other hand, uses the TCP/IP protocol, which is currently used for world-wide communication networks, such as the world-wide-web. The TCP/IP, however, is a more capable, and hence more complex and costly protocol, which is typically embodied via a high speed Ethernet connection. Although TCP/IP is a viable networking solution for computers, high speed printers, servers, and the like, its inherent complexity does not encourage its use in consumer devices such as cameras, DVD players, recorders, and the like. In like manner, the Bluetooth standard supports the use of wireless devices in a networked environment, but is unsuitable for TCP/IP-based communications and control, such as provided by the UPnP standard.

The advantages and disadvantages of each networking solution are likely to result in a variety of networks being installed in a typical home or office environment. With the existence of multiple devices in a typical environment, there is an every increasing need for devices and systems that provide a bridge between and among such heterogeneous networks.

### BRIEF SUMMARY OF THE INVENTION

It is an object of this invention to provide an architecture, method, and system that bridge between IP and non-IP networks. It is a further object of this invention to provide an architecture, method, and system that allow a UPnP-compliant object, such as an application program, to control slave devices that are connected to non-IP networks. It is a further object of this invention to enable the control of non-UPnP-compliant slave devices without modification to the slave devices.

These objects and others are achieved by providing a non-IP network with UPnP proxy enabling logic and interface logic. The UPnP enabling logic provides the modules required to effect the UPnP addressing, discovery, and description processes for each of the devices on one or more non-IP networks. Each of the non-IP networks may use the same or different network technologies. During the UPnP control and event phases, the UPnP proxy enabling logic and interface logic provides the appropriate control transformation and event proxy processes to communicate commands to each non-UPnP-compliant device in the network, corresponding to the UPnP control commands received from a UPnP control object, and to communicate event status messages to and from the non-UPnP-compliant devices and the UPnP-compliant control object. To assure that all commands and events are communicated, multiple simultaneous threads or processes are used, to avoid blocking. Using multiple simultaneous processes also allow the system to be distributed among multiple hosts. In like manner, appropriate memory locking is effected as required to assure consistency and data reliability in a shared memory environment. To ease the programming of the host capabilities, a naming convention is used to provide unique and meaningful process and variable names, and a database architecture is provided to easily store the capability, description, and presentation parameters required for UPnP.

### BRIEF DESCRIPTION OF THE DRAWINGS

The invention is explained in further detail, and by way of example, with reference to the accompanying drawings wherein:

FIG. 1 illustrates an example block diagram of a system comprising UPnP user control points (UCPs) that interact with multiple heterogeneous networks in accordance with this invention.

FIG. 2 illustrates an example block diagram of a system for bridging a non-IP network with UPnP user control points, in accordance with this invention.

FIG. 3 illustrates an example prior art UPnP protocol stack.

FIG. 4 illustrates an example prior art UPnP process.

FIG. 5 illustrates an example block diagram of a UPnP UCP interface and UPnP enabling logic in a system that includes an interface to a non-IP network, in accordance with this invention.

FIG. 6 illustrates an example flow diagram of thread creation to provide a non-blocking architecture for communications between the UPnP UCPs and the non-UPnP devices, in accordance with this invention.

Throughout the drawings, the same reference numerals indicate similar or corresponding features or functions.

### DETAILED DESCRIPTION OF THE INVENTION

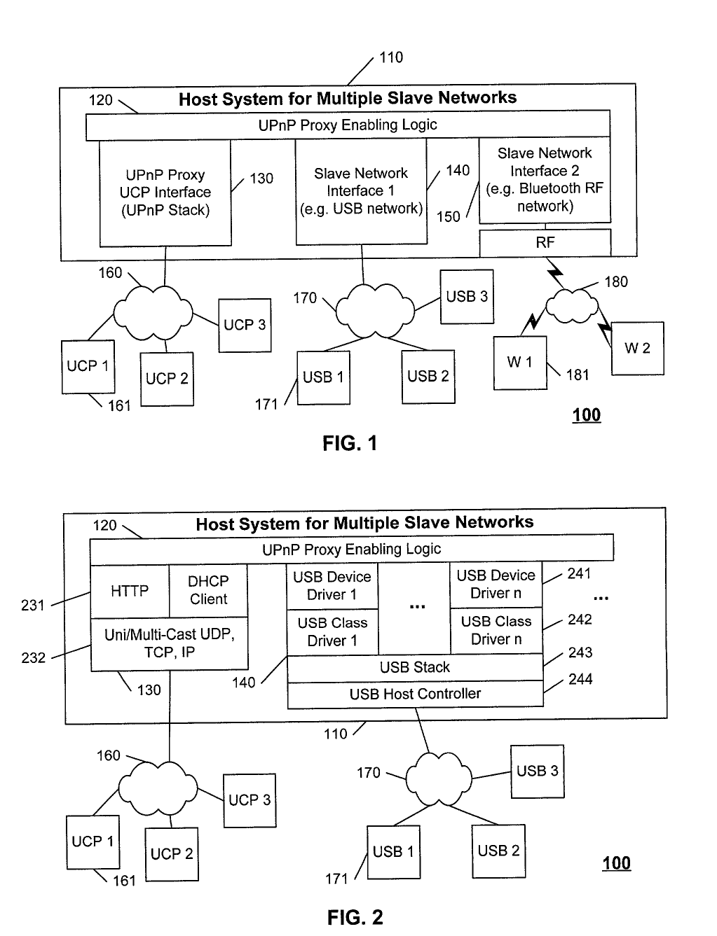

FIG. 1 illustrates an example block diagram of a system 100 comprising UPnP controllers 161 on an IP network 160 that interact with devices 171, 181 on multiple heterogeneous networks 170, 180. For ease of reference, the UPnP controllers 161 are hereinafter referred to as user control points (UCPs), consistent with the commonly used term for such controllers, although the invention is applicable to any form of UPnP-compatible control entities.

In accordance with this invention, UPnP enabling logic 120 in a host system 110 interacts with the controlled, or slave, devices 171, 181 via slave network interfaces 140, 150, respectively. Although a single host system 110 is illustrated, one of ordinary skill in the art will recognize that the host system 110 may be distributed among a variety of devices. An example USB network 170 and a Bluetooth RF network 180 are illustrated, although the principles of this invention are applicable to virtually any network that facilitates control of devices on the network, including a HAVi-compatible network, such as an IEEE 1394 network, a Home API network, a HomeRF network, a Firefly network, a power line network, such as an X-10 network, and a Jini-compatible network.

The UPnP enabling logic 120 in the host system 110 effects the transformation and coordination of commands and messages between the UPnP user control points 161 and the slave devices 171, 181. For ease of reference, UPnP-compliant objects on the IP network 160 are referred to as UPnP objects, and device on the non-IP networks 170, 180 are referred to as non-UPnP devices.

FIG. 2 illustrates an example block diagram of a host system 110 for bridging a non-IP network 170, such as a USB network, with UPnP user control points 161. As illustrated, the UPnP enabling logic 120 interacts with the UCPs 161 on the IP network 160 through a UPnP stack 130 that includes HTTP 231 on top of TCP/IP and UDP/IP 232, which are discussed further below. The UPnP enabling logic 120 also interacts with the slave network interface 140 to effect control and messaging with the slave devices 171. In this example, the USB network interface 140 includes device drivers 241, class drivers 242, a USB stack 243, and a USB Host controller 244, consistent with existing USB standards. As discussed further below, the slave network interface 140 provides the UPnP enabling logic 120 with information about each device 171 on the network 170, the current status (connected/disconnected/standby/etc.) of each device 171, current capabilities of each device 171, and so on.

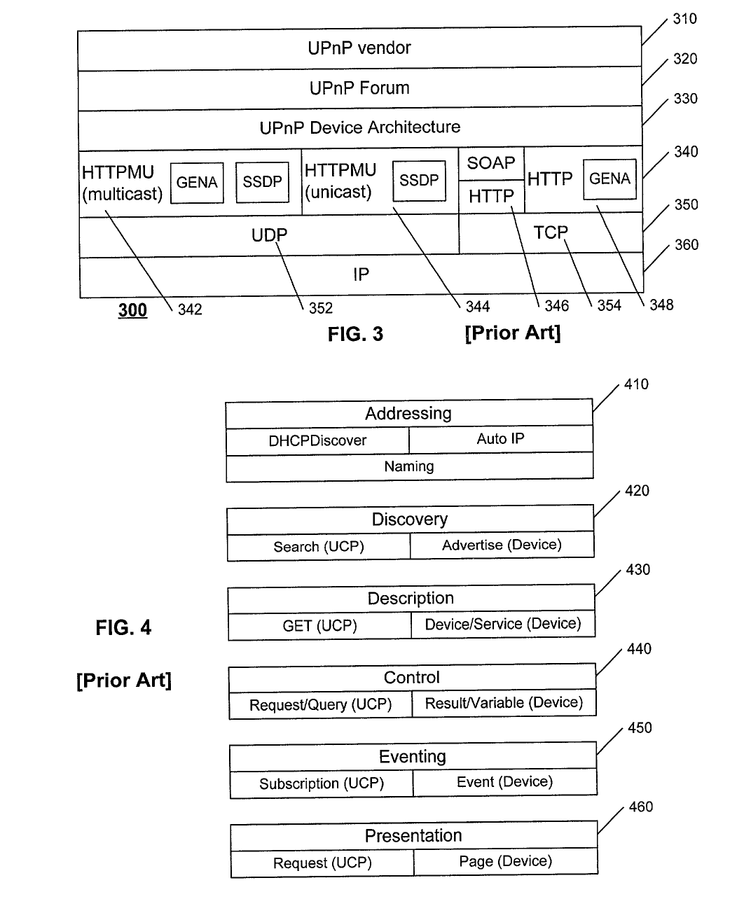

The UPnP Device Architecture defines the protocols for communication between user control points (UCPs) and devices. FIG. 3 illustrates the UPnP protocol stack 300 that is used for the discovery, description, control, eventing, and presentation phases of UPnP network management. At the highest layer 310, messages contain only UPnP vendor-specific information about their devices. Moving down the stack, vendor content 310 is supplemented by information 320 defined by UPnP Forum working committees. Messages from the layers 310, 320 above are hosted in UPnP-specific protocols 330, defined by the UPnP architecture. These protocols 330 are formatted using the Simple Service Discovery Protocol (SSDP), General Event Notification Architecture (GENA), and Simple Object Access Protocol (SOAP), and delivered via HTTP, at level 340. The HTTP 340 is either multicast 342 or unicast 344 running over UDP 352, or standard HTTP 346, 348 running over TCP 354. Each UDP 352 or TCP 354 message, at protocol level 350, is delivered via IP 360.

FIG. 4 illustrates an example UPnP process for establishing and maintaining a network of UPnP controllers (UCPs) and controlled devices. The foundation for UPnP networking is IP addressing. Each device is assigned a unique address, at 410, either via an assignment by a Dynamic Host Configuration Protocol (DHCP) server that is managing the network, or via an Auto IP address generation function, if the network is not managed. Devices may also be assigned a device name, for ease of subsequent references to each device.

Given an IP address, the next step in the UPnP process is discovery 420, wherein each device provides the network with a few essential specifics about the device or its services, with a pointer to more detailed information, as required. The UCPs also use the discovery process to search for devices of particular interest. The devices advertise their essential characteristics when they first enter the network, as well as in response to a search for their characteristics by a UCP. To assure that the network is kept up to date, devices are required to periodically refresh their advertisement via the discovery process 420. Devices are logged off the network when they communicate a logoff message, or when they fail to refresh their advertisement.

The next step in the UPnP process is description 430, wherein UCPs that are interested in advertised devices issue a request for additional information from a URL (Universal Resource Locator) address that is contained in the device advertisement. Typically, this additional information regarding the device and its services is located at the device, but it may also be located at a remote location, such as an Internet site that is maintained by the vendor of the device.

When a UCP learns of a device's capabilities, it is able to control and/or monitor the device, at 440, via an action request or a value query. In response to the action request, the device effects the action, and reports a result. Generally, the result is an acknowledgement that the requested action was effected, but it may be a more detailed message that reports the current device state, and/or the state of one or more variables associated with the device. In response to a value query, the device reports the state of one or more variables identified in the value query.

The UCP may also request notification whenever an event occurs at the device, via the eventing process 450. The UCP ‘subscribes’ to be notified of any change of state at the device, and may exclude specified state changes, such as the change of value of particular variables, from this notification process. Whenever a device changes state, it notifies all subscribers of the event, except those subscribers that have excluded the specific state change from their subscription.

The UCP presents the capabilities and controls associated with a device, based on a presentation page that is provided by the device, at 460. The UCP requests the presentation page from a URL that is provided in the device description. As with the device description at 430, the URL may address the device, or it may address a remote site, such as the vendor's Internet site, or a third-party service provider's site.

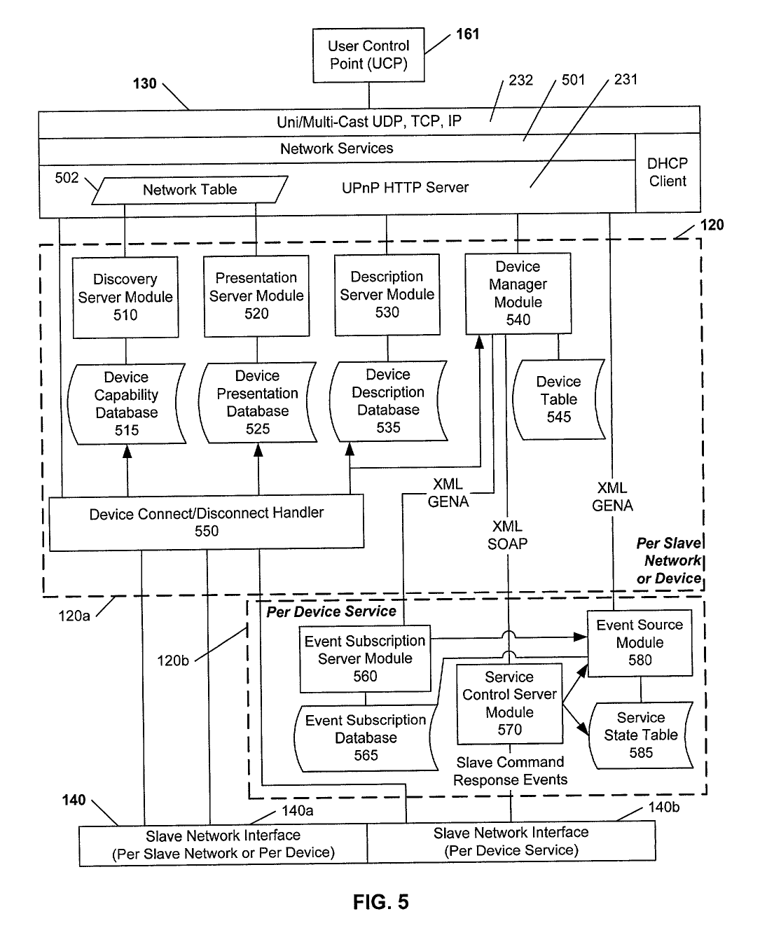

FIG. 5 illustrates an example block diagram of a UPnP UCP interface 130 and UPnP enabling logic 120 in a host system 110 that includes an interface 140 to a non-IP network in accordance with this invention.

The UPnP UCP interface 130 includes a network services layer 501 for accessing the IP network module 232, including creating and managing network communications, formatting appropriate IP messages, and receiving and sending messages. Consistent with conventional practice, the network services layer 501 sends multicast UDP messages multiple times, to enhance reliability.

The UPnP HTTP server 231 is a server process that supports the HyperText Transfer Protocol (HTTP) used for communication between the UPnP UCPs 161 and the controlled devices (171, 181 in FIG. 1), as discussed above with regard to the HTTP protocol layer 340 of FIG. 3. In a preferred embodiment, the HTTP server 231 handles interactions between multiple UCPs 161 and multiple devices, and is configured to provide a non-blocking transfer. This non-blocking transfer is easily effected via the use of threads to handle different types of requests, as discussed further below. The functions provided by a HTTP server 231 in a preferred embodiment include:

creating and managing threads to handle device connect and disconnect, and to handle UPnP defined queries for device capability, description, and presentation;

creating and maintaining a network table 502 that keeps track of each network and the type of threads created for the network, and records the communication data structures for each thread;

monitoring a pre-defined TCP/IP server port and a pre-defined multicast UDP port to receive HTTP messages and to pass them to the corresponding modules that are responsible for the messages; and

providing the Application Program Interface (API) for transforming responses and GENA notifications into proper HTTP messages, and invokes network services 501 to send the messages.

The UPnP HTTP server 231 uses the network table 502 and the value of the HTTP request line, such as the HTTP requests GET, POST, M-POST, M-SEARCH, SUBSCRIBE, and UNSUBSCRIBE for dispatching. For example, upon receipt of an HTTP M-SEARCH request, it dispatches messages to the discover server modules 510 corresponding to each network in the UPnP enabling logic 120, to effect the requested search.

The UPnP proxy enabling logic 120 in a preferred embodiment comprises two parts. A first part 120a includes components that are embodied for each slave network or each device, and a second part 120b includes components that are embodied for each service provided by each slave device in each slave network. For example, a VCR device typically provides a variety of services, including a clock service, a tuner service, and a tape transport service.

The network-level UPnP enabling logic 120a includes the modules 510, 520, 530 required to effect and coordinate the UPnP discovery, presentation, and description phases, respectively, as well as a device manager module 540 that effects and coordinates commands and messages related to each device in the slave network. A device connect/disconnect handler 550 provides information to the appropriate databases 515, 525, 535 that the modules 510, 520, 530 use to respond to UPnP requests regarding the presence of devices on the network, and their capabilities. When activated, the device connect/disconnect handler 550 uses the slave network interface 140 to determine the information about each device in its associated network. Using this information, it fills in the discovery, presentation, and description information at the databases 515, 525, 535, respectively. In a preferred embodiment, after creating and starting one device connect/disconnect handler 550 for each slave network, the HTTP server 231 is placed in a wait state during initialization until at least one of the handlers have finished adding the required information to the corresponding databases. After initialization, the handler 550 monitors each device for connection and disconnection, and updates each database 515, 525, 535 by appropriately adding or deleting device information. The handler 550 also forms one or more GENA notification messages, and invokes the API of the HTTP server 231 to multicast such additions and deletions. The handler 550 also periodically forms an SSDP ‘alive’ message, and invokes the API of the HTTP server 231 to broadcast the message, thereby refreshing each device's active status on the IP network.

The discovery server module 510, and corresponding device capability database 515, implement the UPnP discovery server specification. As noted above, in a preferred embodiment, the discovery module 510 is responsible for providing the UPnP discovery function for each device within its corresponding network. The functions of the discover module 510 in a preferred embodiment include:

providing an API for querying the network or devices for device characteristics;

processing UPnP search messages, such as an M-SEARCH message with an “ssdp:discover” message header; and

upon receipt of an SSDP query, searching the device capability database 515, forming a response, and invoking the aforementioned HTTP server 231 API to return the response to the requester.

The device capability database 515 contains data structures in memory that store information about the capabilities of each device known to the module 510, and is preferably organized for efficient operations for SSDP searches.

The description server module 530 implements the UPnP description server specification, discussed above, for devices that do not have a corresponding remote URL addresses at which the description and/or presentations are located. Initially, it will be expected that devices on a non-IP network will not have an associated UPnP description at a remote URL, address, and thus the UPnP enabling logic 120 will need to provide the description, via a device description database 535. As this invention becomes commonplace, however, vendors or third party developers are likely to develop UPnP descriptions for non-UPnP devices, and the amount of information required to be stored at the device description database 535 will, correspondingly, be substantially reduced. The functions of the description server module 530 include:

providing an API for querying device descriptions;

processes HTTP/GET messages addressed to the local description server that manages the presentation of the description for the devices on the slave network under its responsibility; and

searching the device description database 535 in response to HTTP/GET messages, and invoking the API at the HTTP server 231 to return the response.

The presentation module 520 implements the UPnP presentation server specification, and is configured similar to the description server module 530 to respond to HTTP/GET messages addressed to the local presentation server responsible for devices on the network, using the device presentation database 525 as required.

The device manager module 540 enables multiple UCPs to simultaneously control multiple devices in the slave network under its responsibility, in response to device access and control requests, such as HTTP POST and M-POST messages. The functions of the device manager module include:

creating and managing threads to route and handle device control requests, as discussed below; and

providing an interface for the device connect/disconnect handler to provide notification of device connect and disconnect events.

The device table 545 stores the mapping between a service identification (for example, a device UUID and a service name) and the data structures used to communicate data with the service control server 570 and the event subscription server 560.

The service-level UPnP enabling logic 120b includes an event subscription server module 560, a service control server module 570, and an event source module 580. Typically, a device provides one or more services. Preferably, there is one event subscription server module 560, one service control server module 570, and one event source module 580 associated with each service provided by a device. Correspondingly, there is one event subscription database 565 and one service state table 585 associated with each service.

The service control server module 570 is responsible for effecting control commands directed to its associated service. The functions of the service control server module 570 in a preferred embodiment includes:

parsing SOAP commands, invoking the appropriate driver interface(s) to effect each command, and invoking the API at the HTTP server 231 to send an acknowledgement or failure message to the requester;

updating the service state table 585 upon successful command execution, if the state of the service changes;

monitoring events posted by the slave device, and updating the service state table 585 if the state of the service changes; and

invoking the event source module 580 with each update of the service state table 585.

In a preferred embodiment, because not all slave device drivers are configured to report the entire state of the driven device, the service state table 585 is used to record the current value of the state of the service (power, register values, and so on). The table 585 is initialized when the device enters the UPnP control network and is kept consistent with the state of the service by updating the state every time a state-changing command is successfully executed.

The event subscription server module 560 is responsible for allowing UCPs to express their interest about device events related to each service. The functions of the event subscription server module 560 in a preferred embodiment includes:

parsing GENA event subscription messages, entering the subscribing UCPs identification and subscribed events in the event subscription database 565, and invoking the API of the HTTP server 231 to send an acknowledgement (or failure notification) to the subscriber UCP; and

invoking the event source module 580 to pass the current state of the service to a first-time subscriber UCP.

The event source module 580 is responsible for posting events of the service to all UCPs that have subscribed to the events. The functions of the event source module 580 in a preferred embodiment includes:

providing an interface for the service control server module 570 to pass notifications about the changes in the service status to the service state table 585;

examining the event subscription database, notifying subscriber UCPs of subscribed event changes by forming a GENA notification message, and invoking the API of the HTTP server 231 to send the GENA message; and

providing an interface for the event subscription server module 560 to effect the notification of each first-time subscriber of the state of the service, via the formation and transmission of a GENA notification message, via the API of the HTTP server 231.

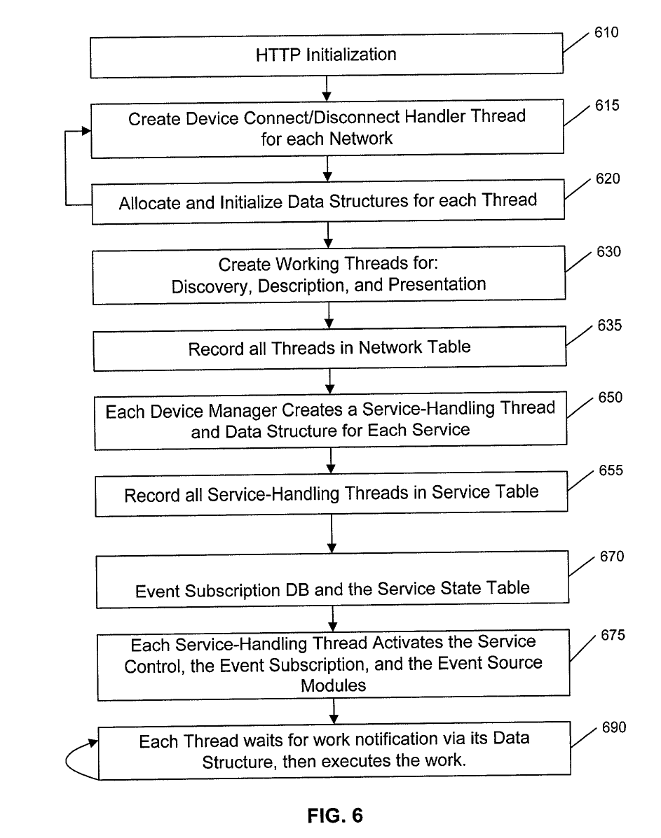

FIG. 6 illustrates an example flow diagram of thread creation to provide a non-blocking architecture for communications between the UPnP UCPs and the slave devices, in accordance with this invention. For convenience and ease of understanding, the foregoing description provides references to items in the previous figures, although the principles presented in this flow diagram are also applicable to other structures or system configurations. The first digit of each reference numeral corresponds to the first figure at which the referenced item is introduced.

At 610, the HTTP server 231 allocates and initializes memory spaces for the network table 502, the device capability database 515, the device description database 535, and the device presentation database 525, for each slave network. The HTTP server 231 also allocates and initializes a space for communication and synchronization between itself and each of the slave network's device connect/disconnect handler 550. At 615, the HTTP server 231 creates a device connect/disconnect handler thread for each network, and waits until at least one of the device connect/disconnect handlers 550 reports that it has successfully initialized the device capability database 515, the device description database 535, and the device presentation database 525. When the HTTP server 231 receives the notification that the device connect/disconnect handler 550 has initialized the databases 515, 525, 535, the HTTP server 231 allocates and initializes a data structure for each working thread that it will create, at 620. These data structures are used to communicate with the threads. The HTTP server 231 repeats the process 615-620 for each network, as each network's device connect/disconnect handler 550 reports a successful initialization of the network's databases 515, 525, 535. At 630, the HTTP server 231 creates working threads, one for handling device discovery, one for handling device description, and one for handling device presentation. Each thread activates the corresponding module 510, 530, 520, and receives a pointer to the database 515, 535, 525 that it will use. At 635, the HTTP server 231 records each network type, each thread type, and the communication data structure for each thread, into the network table 502. Thereafter, the HTTP server 231 directs each device manager 540 to set up service handling threads for the corresponding devices in the network for which the manager is responsible. The manager 540 executes in the context of the HTTP server 231.

At 650, each device manager 540 first queries the discovery service module 510 to obtain a list of devices in the network for which it is responsible. For each device, the manager further queries the description server module to get a list of services provided by the device. The manager then creates a service-handling thread for each service provided by each device, and a corresponding data structure for communicating with each thread. At 655, the device manager 540 records the mapping of each thread to each service provided by the device in the device table 545.

At 670, each service-handler thread allocates and initializes the event subscription database 565 and the service state table 585 for its associated service. At 675, each service-handler thread activates each of the service control 570, event subscription 560, and event source 580 modules associated with the service.

Not illustrated, when a device is added to the network, the device manager 540 creates and records a service-handler thread for each service provided by the device, as in blocks 650-655. The newly created service-handler thread creates and initializes the service-specific database 565 and table 585, and activates the modules 560, 570, 580, as in blocks 670-675, above.

At 690, all threads created in blocks 630 and 650 wait until being notified of pending work, via the data structure associated with each thread. When the HTTP server 231 identifies an incoming request for a particular working thread, the server 231 places the request into the data structure corresponding to the thread, then returns to handle the next request. In this manner, the HTTP server 231 devotes substantially little time to the processing of request; the actual processing of each request is effected via a single placement of the request into an appropriate data structure. In a preferred embodiment, each thread periodically checks the contents of its data structure. When one or more items of the data structure change, the thread determines the appropriate action to take in response to the change, and reacts accordingly. After the work is completed, the thread invokes the API at the HTTP server 231 to communicate an acknowledgement (or a failure notice if the request was not fulfilled) to the UCP that issued the incoming request. In the case of an incoming control command, the command is placed in communication data structure of the service-handling thread of the targeted service. When the service-handling thread detects this command in its data structure, it determines the type of command. If the command is an event subscription, it passes the command to the event description server module 560. If the command is a service control command, the command is passed to the device control server module 570.

Alternative thread initiation and control schemes will be readily apparent to one of ordinary skill in the art. For example, a thread can be created when a request for a particular service arrives for the first time. In this scheme, for example, the device manager 540 provides an interface for the device description server module 530 to pass a notification when a description is requested by a UCP. Upon receiving the notification, the device manager 540 checks the device table 545 to determine if the service-handling thread already exists for the device; if not, a thread is created for each service provided by the device. In this manner, service-handling threads are only created for devices for which at least one UCP has expressed interest. Alternatively, although threads may be expected to provide an efficient implementation, processes can be used to implement the enabling logic in lieu of threads. Such processes will communicate either via shared memory, as in the case of threads, or via message passing. When message passing is chosen for process communication, the processes can execute on either a single or multiple processors or computers.

As presented above, an embodiment of this invention provides a means for facilitating the control of non-UPnP devices via a UPnP controller. As will be evident to one of ordinary art, if, as in the examples provided, shared memory is used for communication and synchronization, proper locking mechanisms, common in the art, should be used to ensure proper operation. It is important, for example, for the device capability database 515, the device description database 535, the device presentation database 525, and the device table 545 to be consistent, and therefore atomic operations for updating each database should be enforced. For example, write operations to a database or table will typically take priority over read operations, to assure that the read operation is provided the freshest data. These and other means of maintaining data consistency are common in the art.

In a preferred embodiment of this invention, the use of a consistent naming convention scheme is used to simplify the design. For example, the local part of the URL that is used for each server has the prefix: network_type/server_type, such as “usb/descriptionServer”, or “bluetooth/presentationServer”, and so on. To facilitate locating of device files by the device connect/disconnect handler 550, each file name contains an identifier of the device, and the contents of the file, such as “laser_printer.description”, or “scanner.capability”. These names may be made more specific by including, for example, an indication of the make or model of the device. If device functions are provided via library functions, the function names contain a prefix that uniquely identifies the device, thereby avoiding function names conflicts.

The foregoing merely illustrates the principles of the invention. It will thus be appreciated that those skilled in the art will be able to devise various arrangements which, although not explicitly described or shown herein, embody the principles of the invention and are thus within its spirit and scope. For example, different techniques can be employed for managing the information in the device databases. In one embodiment, all the data that is known for any device is stored in persistent storage, and a flag is maintained with each data set to signal whether the corresponding device is currently connected or disconnected from the network. In another embodiment, the data set is added and removed from the databases as each device is connected and disconnected from the network. The first embodiment decreases the “log-in” time for a device that commonly leaves and re-enters the network, but at the cost of additional memory. The second embodiment optimizes the use of memory, but requires that the databases associated with a device be created and initialized each time the device re-enters the network. Note also that the particular functional partitioning presented in the figures is presented for illustrative purposes, and that various combinations of hardware and software implementations may be used to embody the invention. These and other system configuration and optimization features will be evident to one of ordinary skill in the art in view of this disclosure, and are included within the scope of the following claims.

I claim:

1. A system for facilitating UPnP control of at least one non-UPnP device on one or more slave networks, the one or more slave networks including one or more different networking technologies, the system comprising:
a UPnP interface to at least one UPnP controller, the UPnP controller being configured to issue a UPnP command in conformance with a UPnP protocol, and
a UPnP proxy enabler that is configured to:
receive the UPnP command,
transform the UPnP command into a device command,
communicate the device command to a target device of the at least one non-UPnP device on the slave networks, and
communicate a UPnP acknowledgement of the UPnP command to the at least one UPnP controller, via the UPnP interface.

2. The system of claim 1, wherein the one or more different networking technologies include at least one of: a USB network, a bluetooth network, a HAVi-compatible network, an IEEE 1394 network, a Home API network, a HomeRF network, a Firefly network, a power line network, an X-10 network, and a Jini-compatible network.

3. The system of claim 1, wherein:
the UPnP controller is further configured to issue a UPnP request in conformance with the UPnP protocol,
the UPnP request includes one of: a description request, a presentation request, a subscription request, and a query, and
the UPnP proxy enabler is configured to provide at least one of: a device description, a service description, a presentation page, an event, and a value of a variable, in response to the UPnP request.

4. The system of claim 1, wherein
the UPnP proxy enabler includes at least one of:
a discovery module that is configured to provide an advertisement of at least one non-UPnP device to the UPnP controller,
a description module that is configured to provide a description of functions of the at least one non-UPnP device to the UPnP controller, in response to a request from the UPnP controller, and
a presentation module that is configured to provide a presentation page that facilitates a control of the at least one non-UPnP device by a user.

5. The system of claim 4, wherein
at least one of the discovery module, the description module, and the presentation module is configured to provide the advertisement, the description, and the presentation page, respectively, for the at least one non-UPnP device of the slave networks.

6. The system of claim 1, wherein
the UPnP proxy enabler includes at least one of:
a device control module that communicates commands to the target device,
an event subscription module that receives requests from the at least one UPnP controller to be notified of one or more changes of state of the target device, and
an event source module that notifies the at least one UPnP controller of one or more changes of state of the target device.

7. The system of claim 6, wherein p1 the device control module maintains a service state table that reflects the state of the target device, and
the event source module notifies the at least one UPnP controller of the one or more changes of the state of the target device based on the service state table.

8. The system of claim 1, wherein the UPnP proxy enabler communicates the device command to the target device by modifying a data structure that is associated with a thread, and the thread effects the communication to the at least one non-UPnP device of the slave networks.

9. The system of claim 1, wherein the UPnP proxy enabler is further configured to
detect a connection and disconnection of the at least one non-UPnP device, and
update one or more data structures associated with the slave networks accordingly.

10. The system of claim 9, wherein the UPnP proxy enabler is further configured to
initiate and terminate threads based on the connection and disconnection of each of the at least one non-UPnP device.

11. A method for facilitating UPnP control of at least one non-UPnP device on a non-IP slave network, comprising:
receiving a UPnP command in conformance with a UPnP protocol from a UPnP controller,
transforming the UPnP command into a device command,
communicating the device command to a target device of the at least one non-UPnP device on the non-IP slave network, and
communicating a UPnP acknowledgement of the UPnP command to the UPnP controller.

12. The method of claim 11, wherein the non-IP slave network is one of: a USB network, a bluetooth network, a HAVi-compatible network, an IEEE 1394 network, a Home API network, a HomeRF network, a Firefly network, a power line network, an X-10 network, and a Jini-compatible network.

13. The method of claim 11, further including:
receiving a UPnP request in conformance with the UPnP protocol,
the UPnP request including one of: a description request, a presentation request, a subscription request, and a query, and
providing at least one of: a device description, a service description, a presentation page, an event, and a value of a variable, in response to the UPnP request.

14. The method of claim 11, further including at least one of:
providing an advertisement of at least one non-UPnP device to the UPnP controller,
providing a description of functions of the at least one non-UPnP device to the UPnP controller, in response to a request from the UPnP controller, and
providing a presentation page that facilitates a control of the at least one non-UPnP device by a user.

15. The method of claim 14, wherein
at least one of the advertisement, the description, and the presentation page are provided by a common UPnP proxy enabler for the non-IP slave network that is configured to provide advertisements, descriptions, and presentation pages for each non-UPnP device in the non-IP slave network.

16. The method of claim 11, further including
receiving requests from the UPnP controller to be notified of one or more changes of state of the at least one non-UPnP device, and
notifying the UPnP controller of one or more changes of state of the at least one non-UPnP device.

17. The method of claim 16, further including
maintaining a service state table that reflects the state of the target device, and
notifying the UPnP controller of the one or more changes of the state of the at least one non-UPnP device based on the service state table.

18. The method of claim 1 1, further including
creating a thread that is associated with the at least one non-UPnP device of the slave network, and
modifying a data structure that is associated with the thread; and
wherein the thread is configured to effect the communication of the device command to the at least one non-UPnP device of the slave network, based on the modification of the data structure.

19. A network comprising:
an IP sub-network,
a non-IP sub-network, and
a UPnP proxy enabler that facilitates communication and control between the IP sub-network and the non-IP sub-network.

20. The network of claim 19, wherein
the UPnP proxy enabler is configured to:
receive a UPnP command from a UPnP controller on the IP sub-network,
transform the UPnP command into a device command, and
communicating the device command to a device on the non-IP sub-network.

21. The network of claim 19, wherein
the UPnP proxy enabler is further configured to provide at least one of: a device description, a service description, a presentation page, an event, and a value of a variable corresponding to the device on the non-IP network, in response to a UPnP request from the UPnP controller on the IP sub-network.

22. The network of claim 19, wherein
the UPnP proxy enabler facilitates the communication and control between the IP sub-network and the non-IP sub-network via the use of threads that provide a non-blocking communication.
